(19) United States
(12) Patent Application Publication
(10) Pub. No.: US 2024/0310223 A1
(43) Pub. Date: Sep. 19, 2024

(54) LOAD SENSOR

(71) Applicant: Panasonic Intellectual Property Management Co., Ltd., Osaka (JP)

(72) Inventors: Susumu URAGAMI, Kumamoto (JP); Takafumi HAMANO, Fukuoka (JP); Yuta MORIURA, Osaka (JP); Takashi MATSUMOTO, Osaka (JP); Hironobu UKITSU, Osaka (JP); Yodai MATSUMURA, Osaka (JP)

(21) Appl. No.: 18/677,398

(22) Filed: May 29, 2024

Related U.S. Application Data
(63) Continuation of application No. PCT/JP2022/039369, filed on Oct. 21, 2022.

(30) Foreign Application Priority Data
Dec. 3, 2021 (JP) 2021-196850

(51) Int. Cl. G01L 1/14

(52) U.S. Cl. CPC G01L 1/142

(57) ABSTRACT

A load sensor includes: a first base member; a second base member; a plurality of electrically-conductive elastic bodies formed so as to extend in a first direction on an opposing face of the first base member; a plurality of conductor wires extending in a second direction crossing the first direction between the first base member and the second base member; a dielectric body disposed between the electrically-conductive elastic body and the conductor wire; and a thread configured to sew and fasten the plurality of conductor wires to the first or second base member. A plurality of stitch rows, of the thread, in each of which stitches are arranged in the first direction are formed at a predetermined pitch in the second direction. Waving that supports a load does not occur, at least in a load detection range, in the target base member.

### CROSS REFERENCE TO RELATED APPLICATION

This application is a continuation of International Application No. PCT/JP2022/039369 filed on Oct. 21, 2022, entitled “LOAD SENSOR”, which claims priority under 35 U.S.C. Section 119 of Japanese Patent Application No. 2021-196850 filed on Dec. 3, 2021, entitled “LOAD SENSOR”. The disclosures of the above applications are incorporated herein by reference.

### BACKGROUND OF THE INVENTION

### Field of the Invention

The present invention relates to a load sensor that detects a load applied from outside, based on change in capacitance.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

International Publication No. WO2020/153029 describes a pressure-sensitive element (load sensor) that includes: a sheet-shaped base member including an elastic electrically-conductive part; a plurality of conductor wires disposed so as to cross the elastic electrically-conductive part; a plurality of dielectric bodies respectively disposed between the plurality of conductor wires and the elastic electrically-conductive part; and a thread-shaped member that sews the plurality of conductor wires to the base member.

In the load sensor as above, each conductor wire is sewn and fastened, by a thread, to either one of two base members sandwiching the conductor wire. In this case, when large waving has occurred in the base member due to the tension of the thread, a state where the base member supports a part of the load applied to the load sensor is established, whereby the load cannot be accurately detected.

### SUMMARY OF THE INVENTION

A main aspect of the present invention relates to a load sensor. A load sensor according to the present aspect includes: a first base member; a second base member disposed so as to oppose the first base member; a plurality of electrically-conductive elastic bodies formed so as to extend in a first direction on an opposing face of the first base member; a plurality of conductor wires extending in a second direction crossing the first direction, the plurality of conductor wires being disposed so as to be arranged between the first base member and the second base member; a dielectric body disposed between the electrically-conductive elastic body and the conductor wire; and a thread configured to sew and fasten the plurality of conductor wires to the first base member or the second base member. A plurality of stitch rows, of the thread, in each of which stitches are arranged in the first direction are formed at a predetermined pitch in the second direction. The conductor wire is sewn and fastened to a target base member by the thread in a predetermined space between the stitches adjacent to each other on each of the stitch rows. The thread is sewn to the target base member such that waving that supports a load does not occur, at least in a load detection range, in the target base member.

In the load sensor according to the present aspect, waving that supports the load is suppressed from occurring in the base member to which a plurality of conductor wires are sewn and fastened. Therefore, the applied load can be accurately detected.

The effects and the significance of the present invention will be further clarified by the description of the embodiments below. However, the embodiments below are merely some examples for implementing the present invention. The present invention is not limited to the description of the embodiments below in any way.

### BRIEF DESCRIPTION OF THE DRAWINGS

FIG. 1A and FIG. 1B each schematically show a configuration of a structure in a manufacturing step according to Embodiment 1;

FIG. 2A schematically shows a configuration of a structure in a manufacturing step according to Embodiment 1;

FIG. 2B is a perspective view schematically showing a configuration of a load sensor according to Embodiment 1;

FIG. 3 schematically shows a cross section of the load sensor along a plane parallel to an X-Z plane at the position of a thread according to Embodiment 1;

FIG. 4A and FIG. 4B each schematically show a cross section of the vicinity of a crossing position between an electrically-conductive elastic body and a wire along a plane parallel to an X-Z plane at the crossing position according to Embodiment 1;

FIG. 5 is a plan view schematically showing a configuration of the inside of the load sensor according to Embodiment 1;

FIG. 6A and FIG. 6B are each a cross-sectional view schematically showing a state where waving has occurred in a second base member;

FIG. 7A and FIG. 7B each describe a determination criterion as to whether or not a load can be accurately detected, according to Embodiment 1;

FIG. 8A and FIG. 8B are each a schematic diagram describing a condition of examination regarding waving according to Embodiment 1;

FIG. 9 shows set values and examination results of Configurations 1 to 4 used in the examination regarding waving according to Embodiment 1;

FIG. 10 shows actual plan views of Configurations 1 to 4 used in the examination regarding waving, cross-sectional views schematically showing Configurations 1 to 4, and results of waving states of Configurations 1 to 4 according to Embodiment 1;

FIG. 11A schematically shows a configuration of a structure in a manufacturing step according to Embodiment 2;

FIG. 11B is a perspective view schematically showing a configuration of the load sensor according to Embodiment 2;

FIG. 12A schematically shows a cross section of the vicinity of a crossing position between an electrically-conductive elastic body and a wire along a plane parallel to an X-Z plane at the crossing position according to Embodiment 2;

FIG. 12B is a cross-sectional view schematically showing a state where waving has occurred in a first base member;

FIG. 13A is a plan view and a cross-sectional view schematically showing the vicinity of a gap between two electrically-conductive elastic bodies adjacent to each other in the Y-axis direction according to Embodiment 2;

FIG. 13B is a plan view and a cross-sectional view schematically showing a structure obtained by joining the electrically-conductive elastic bodies in FIG. 13A together at a stitch row according to Embodiment 2; and

FIG. 14 schematically shows a cross section of the vicinity of a crossing position between an electrically-conductive elastic body and a wire along a plane parallel to an X-Z plane at the crossing position according to Modification.

It is noted that the drawings are solely for description and do not limit the scope of the present invention in any way.

### DETAILED DESCRIPTION

A load sensor according to the present invention is applicable to a load sensor of a management system or an electronic apparatus that performs processing in accordance with an applied load.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected. Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

Examples of the electronic apparatus include a vehicle-mounted apparatus (car navigation system, audio apparatus, etc.), a household electrical appliance (electric pot, IH cooking heater, etc.), a smartphone, an electronic paper, an electronic book reader, a PC keyboard, a game controller, a smartwatch, a wireless earphone, a touch panel, an electronic pen, a penlight, lighting clothes, and a musical instrument. In an electronic apparatus, a load sensor is provided to an input part that receives an input from a user.

The load sensor in the embodiments below is a capacitance-type load sensor that is typically provided in a load sensor of a management system or an electronic apparatus as described above. Such a load sensor may be referred to as a “capacitance-type pressure-sensitive sensor element”, a “capacitive pressure detection sensor element”, a “pressure-sensitive switch element”, or the like. The load sensor in the embodiments below is connected to an external detection circuit, and the load sensor and the detection circuit form a load detection device. The embodiments below are some examples of embodiments of the present invention, and the present invention is not limited to the embodiments below in any way.

Hereinafter, embodiments of the present invention will be described with reference to the drawings. For convenience, X-, Y-, and Z-axes orthogonal to each other are indicated in the drawings. The Z-axis direction is the height direction of a load sensor 1.

### Embodiment 1

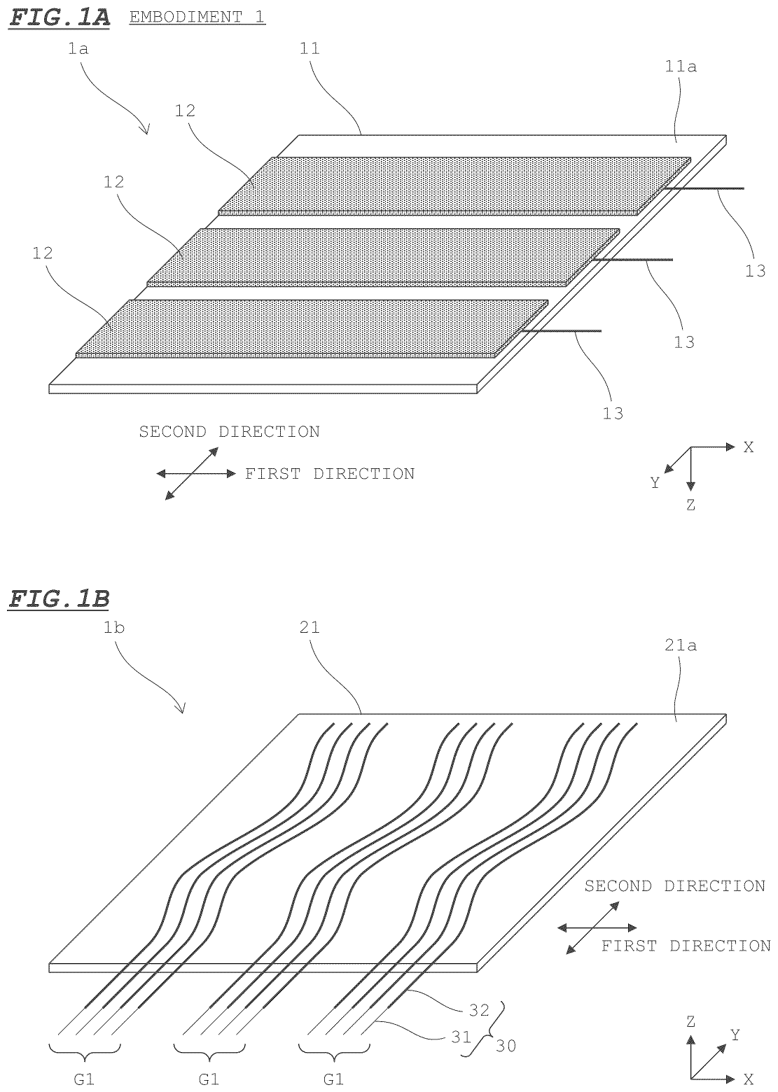

FIG. 1A schematically shows a configuration of a structure 1a in a manufacturing step.

The structure 1a includes a first base member 11, a plurality of electrically-conductive elastic bodies 12, and a plurality of wiring cables 13.

The plurality of electrically-conductive elastic bodies 12 are set on an opposing face 11a (the face on the Z-axis negative side) of the first base member 11. The wiring cables 13 are respectively connected to the plurality of electrically-conductive elastic bodies 12. Here, three electrically-conductive elastic bodies 12 are formed on the opposing face 11a. The number of the electrically-conductive elastic bodies 12 set on the opposing face 11a is not limited thereto.

The first base member 11 is a flat-plate-shaped member having elasticity. The first base member 11 has a rectangular shape in a plan view. The thickness of the first base member 11 is constant. When the thickness of the first base member 11 is small, the first base member 11 may be referred to as a sheet member or a film member.

The first base member 11 has an insulation property and is formed from a non-electrically-conductive resin material or a non-electrically-conductive rubber material, for example. The resin material used in the first base member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the first base member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The thickness of the first base member 11 is set to 0.02 mm or more and 1 mm or less, for example. The elastic modulus of the first base member 11 is set to 1 MPa or more and 3 MPa or less, for example.

The electrically-conductive elastic bodies 12 are formed so as to extend in a first direction (the X-axis direction) on the opposing face 11a of the first base member 11. The electrically-conductive elastic bodies 12 are each an electrically-conductive member having elasticity. Each electrically-conductive elastic body 12 has a band-like shape that is long in the first direction (the X-axis direction), and is disposed so as to extend in the first direction (the X-axis direction). That is, the long side of the electrically-conductive elastic body 12 is parallel to the X-axis. The widths, the lengths, and the thickness of the three electrically-conductive elastic bodies 12 are the same with each other. A predetermined gap is provided between adjacent electrically-conductive elastic bodies 12. One end of each wiring cable 13 is connected to a corresponding electrically-conductive elastic body 12 and the other end of the wiring cable 13 is connected to a detection circuit.

Each electrically-conductive elastic body 12 is formed on the opposing face 11a of the first base member 11 by a printing method such as screen printing, gravure printing, flexographic printing, offset printing, or gravure offset printing. With these printing methods, the electrically-conductive elastic body 12 can be formed so as to have a thickness of about 0.001 mm to 0.5 mm on the opposing face 11a of the first base member 11. However, the forming method for the electrically-conductive elastic body 12 is not limited to the printing method.

Each electrically-conductive elastic body 12 is formed from a resin material and an electrically-conductive filler dispersed therein, or from a rubber material and an electrically-conductive filler dispersed therein.

Similar to the resin material used in the first base member 11 described above, the resin material used in the electrically-conductive elastic body 12 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. Similar to the rubber material used in the first base member 11 described above, the rubber material used in the electrically-conductive elastic body 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electrically-conductive elastic body 12 is a material of at least one type selected from the group consisting of: metal materials such as Au (gold), Ag (silver), Cu (copper), C (carbon), Zno (zinc oxide), In₂O₃ (indium oxide (III)), and SnO₂ (tin oxide (IV); electrically-conductive macromolecule materials such as PEDOT: PSS (i.e., a complex composed of poly (3,4-ethylenedioxythiophene) (PEDOT) and polystyrene sulfonate (PSS); and electrically-conductive fibers such as a metal-coated organic matter fiber and a metal wire (fiber state), for example.

The thickness of each electrically-conductive elastic body 12 is set to 1 μm or more and 30 μm or less, for example. The elastic modulus of the electrically-conductive elastic body 12 is set to 0.5 MPa or more and 3 MPa or less, for example.

FIG. 1B schematically shows a configuration of a structure 1b in a manufacturing step.

The structure 1b includes a second base member 21 and a plurality of wires 30.

The plurality of wires 30 are disposed on an opposing face 21a (the face on the Z-axis positive side) of the second base member 21. Here, three wire groups Gl each composed of four wires 30 are disposed on the opposing face 21a, and a total of twelve wires 30 are disposed on the opposing face 21a. The number of the wires 30 disposed on the opposing face 21a is not limited thereto.

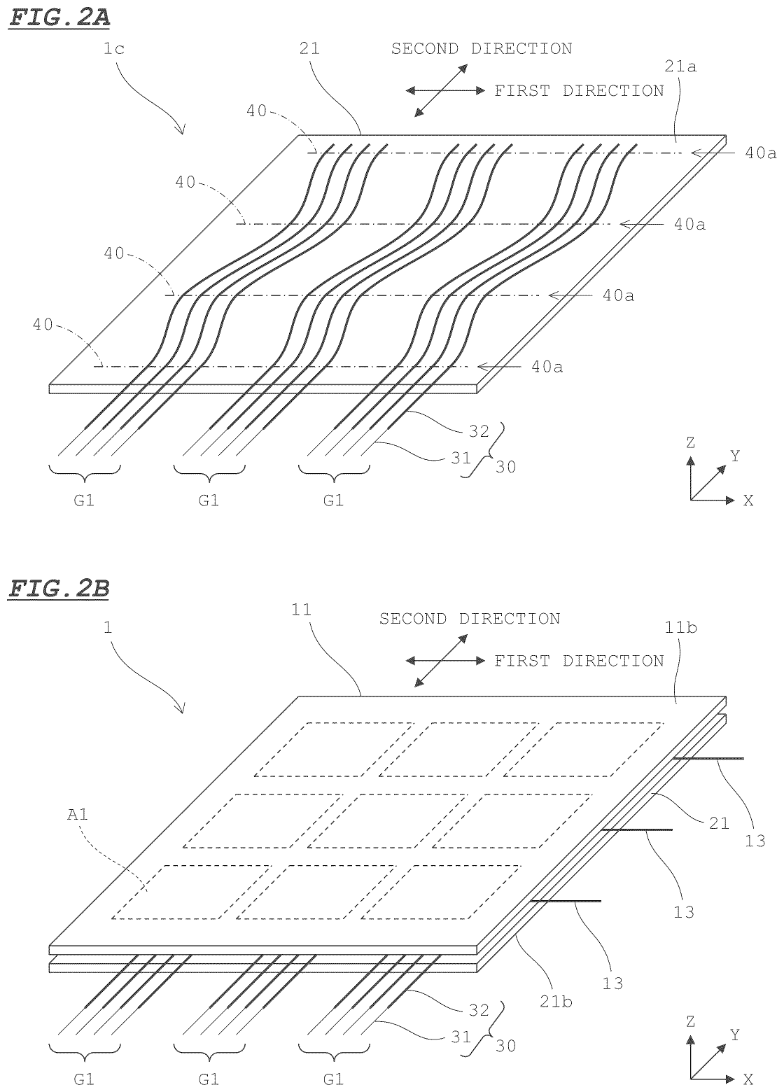

The second base member 21 is a flat-plate-shaped member having elasticity. The second base member 21 is disposed so as to oppose the first base member 11 as described later with reference to FIG. 2B. The second base member 21 has a shape similar to that of the first base member 11 in a plan view. The thickness of the second base member 21 is constant. When the thickness of the second base member 21 is small, the second base member 21 may be referred to as a sheet member or a film member.

The second base member 21 has an insulation property and is formed from a non-electrically-conductive resin material or a non-electrically-conductive rubber material, for example. The second base member 21 is formed from a material that can be used in the first base member 11 described above, for example. More specifically, the second base member 21 is formed from silicone rubber, ethylene-propylene-diene rubber, urethane rubber, fluororubber, nitrile rubber, acrylic rubber, or ethylene-propylene rubber.

The wires 30 extend in the Y-axis direction (second direction) and are disposed so as to be arranged between the first base member 11 and the second base member 21 in a state where assembly of the load sensor 1 has been completed. Each wire 30 has a linear shape and meanders so as to slightly swing in the X-axis direction. The wire groups Gl each composed of four wires 30 are arranged with a predetermined interval therebetween in the X-axis direction (the first direction). The four wires 30 in each wire group Gl are also arranged with a predetermined interval therebetween in the X-axis direction (the first direction).

Each wire 30 is composed of a conductor wire 31 and a dielectric body 32 formed on the conductor wire 31. The dielectric body 32 is formed on the outer periphery of the conductor wire 31 and covers the surface of the conductor wire 31. An end portion on the Y-axis negative side of the conductor wire 31 is not covered by the dielectric body 32, and this end portion is connected to the detection circuit.

Each conductor wire 31 is a member having electrical conductivity and having a linear shape. The conductor wire 31 is formed from an electrically-conductive metal material, for example. Other than this, the conductor wire 31 may be composed of a core wire made of glass and an electrically-conductive layer formed on the surface of the core wire. Alternatively, the conductor wire 31 may be composed of a core wire made of resin, and an electrically-conductive layer formed on the surface of the core wire, for example. For example, as the conductor wire 31, a valve action metal such as aluminum (Al), titanium (Ti), tantalum (Ta), niobium (Nb), zirconium (Zr), or hafnium (Hf; tungsten (W; molybdenum (Mo; copper (Cu; nickel (Ni; silver (Ag; gold (Au; or the like is used. In Embodiment 1, the conductor wire 31 is formed from copper. The conductor wire 31 may be a twisted wire obtained by twisting wire members made of an electrically-conductive metal material.

The dielectric body 32 has an electric insulation property, and is formed from a resin material, a ceramic material, a metal oxide material, or the like, for example. The dielectric body 32 may be a resin material of at least one type selected from the group consisting of a polypropylene resin, a polyester resin (e.g., polyethylene terephthalate resin), a polyimide resin, a polyphenylene sulfide resin, a polyvinyl formal resin, a polyurethane resin, a polyamide imide resin, a polyamide resin, and the like. Alternatively, the dielectric body 32 may be a metal oxide material of at least one type selected from the group consisting of Al₂O₃, Ta₂O₅, and the like.

The diameter of the conductor wire 31 is 0.01 mm or more and 1.5 mm or less, for example, or may be 0.05 mm or more and 0.8 mm or less. Such a configuration of the conductor wire 31 is preferable from the viewpoint of the resistance and the strength of the conductor wire 31. The thickness of the dielectric body 32 is preferably 5 nm or more and 100 μm or less, and can be selected as appropriate according to the design of the sensitivity of the sensor and the like.

FIG. 2A schematically shows a configuration of a structure 1c in a manufacturing step.

In the structure 1c, the wires 30 are sewn to the structure 1b in FIG. 1B by threads 40.

Each wire 30 is sewn and fastened to the opposing face 21a of the second base member 21 by the threads 40. A stitch row 40a of each thread 40 extends in the X-axis direction (the first direction). On the stitch row 40a, the thread 40 sews and fastens, across all of the wires 30, each wire 30 to the second base member 21. In FIG. 2A, four stitch rows 40a of the threads 40 are provided to the second base member 21. When the load sensor 1 has been completed, in a plan view, two stitch rows 40a of the threads 40 on the inner side are each positioned at the gap between two electrically-conductive elastic bodies 12 adjacent to each other in the Y-axis direction, and two stitch rows 40a of the threads 40 on the outer side are respectively positioned on the further outer side with respect to two electrically-conductive elastic bodies 12 on the outer side in the Y-axis direction. Each wire 30, in a state of being sewn and fastened by the threads 40, is movable in the Y-axis direction, and is restricted in movement in the X-axis direction by the threads 40. The thread 40 is implemented by a chemical fiber, a natural fiber, a mixed fiber of the chemical fiber and the natural fiber, or the like.

FIG. 2B is a perspective view schematically showing a configuration of the load sensor 1.

The structure 1a in FIG. 1A is superposed with its front face and back face reversed, from above (the Z-axis positive side) the structure 1c in FIG. 2A. Accordingly, the wires 30 come into contact with the electrically-conductive elastic bodies 12 formed on the first base member 11. Then, the outer periphery of the first base member 11 is connected by a thread (not shown) to the second base member 21, whereby the first base member 11 is fixed to the second base member 21. Then, the load sensor 1 is completed as shown in FIG. 2B.

The load sensor 1 of Embodiment 1 is used in a state where the first base member 11 is oriented to the upper side (the Z-axis positive side) and the second base member 21 is oriented to the lower side (the Z-axis negative side). In this case, an upper face 11b of the first base member 11 serves as the face to which a load is applied, and a lower face 21b of the second base member 21 is set on an installation surface.

Here, in the load sensor 1, in a plan view, a plurality of element parts A1 arranged in a matrix shape are formed. In the load sensor 1 in FIG. 2B, a total of nine element parts A1 arranged in the X-axis direction and the Y-axis direction are formed. One element part Al corresponds to a region including the intersection between an electrically-conductive elastic body 12 and a wire group G1 disposed below the electrically-conductive elastic body 12. That is, one element part A1 includes the first base member 11, the electrically-conductive elastic body 12, the wires 30, and the second base member 21 that are near the intersection. When the lower face (the lower face 21b of the second base member 21) of the load sensor 1 is set on a predetermined installation surface, and a load is applied to the upper face (the upper face 11b of the first base member 11) of the load sensor 1 forming the element part Al, the capacitance between the electrically-conductive elastic body 12 and the conductor wires 31 changes, and the load is detected based on the capacitance.

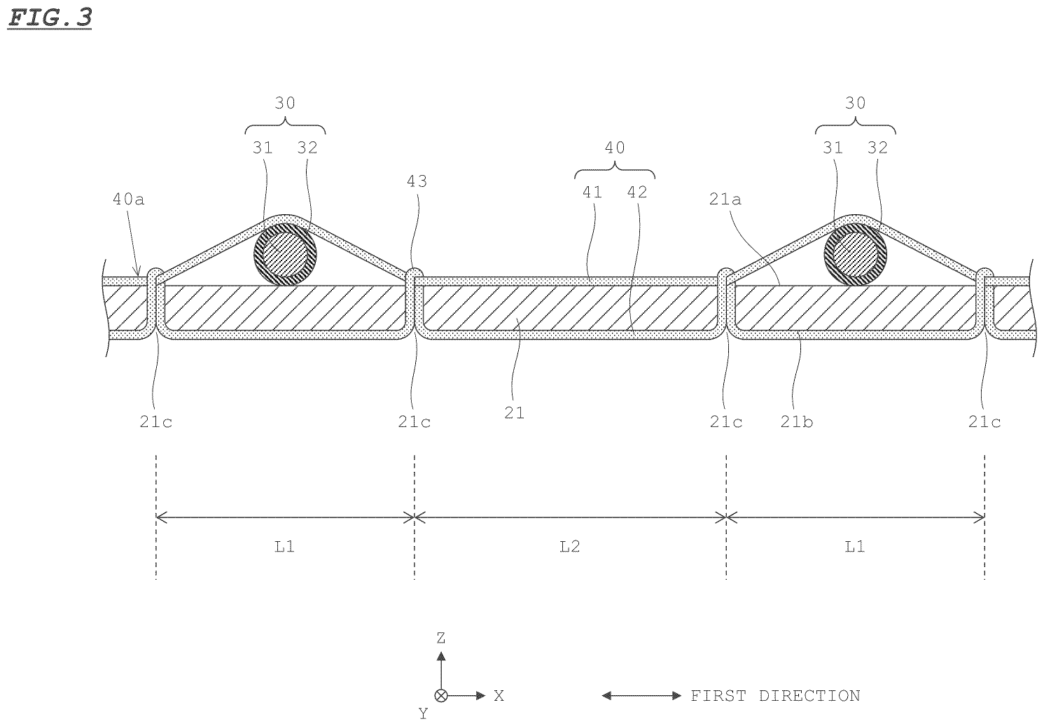

FIG. 3 schematically shows a cross section of the load sensor 1 along a plane parallel to an X-Z plane at the position of a thread 40. In FIG. 3, for convenience, only the second base member 21, the wires 30, and the thread 40 are shown.

Each thread 40 is composed of a needle thread 41 provided along the upper face (the opposing face 21a) of the second base member 21, and a bobbin thread 42 provided along the lower face 21b of the second base member 21. The needle thread 41 and the bobbin thread 42 cross each other at the position of each needle hole 21c penetrating the second base member 21 in the Z-axis direction, and a stitch 43 is formed at this crossing position. Along the X-axis direction, the thread 40 is sewn to the second base member 21. Accordingly, a plurality of stitches 43 are arranged in the X-axis direction.

The plurality of stitches 43 arranged in the X-axis direction (the first direction) and the thread 40 between adjacent stitches 43 form the stitch row 40a of the thread 40. A plurality of the stitch rows 40a of the threads 40 are formed, at a predetermined pitch in the Y-axis direction (the second direction), on the opposing face 21a of the second base member 21. Each wire 30 is sewn and fastened to the second base member 21 by the thread 40 in a space between adjacent stitches 43 on each of the stitch rows 40a. In order to suppress movement in the X-axis direction of the wire 30, it is preferable that the needle hole pitch at the position of the wire 30, that is, the interval between two stitches 43 sandwiching one wire 30, is as small as possible.

Sewing of the thread 40 to the second base member 21 is performed by a sewing machine, for example. The sewing machine forms needle holes 21c at a predetermined pitch in the X-axis direction and forms stitches 43 by crossing the needle thread 41 and the bobbin thread 42 at the needle holes 21c, thereby sewing and fastening the wires 30 to the second base member 21.

In this case, the pitch (the needle hole pitch) in the X-axis direction between the needle holes 21c is determined based on the machine accuracy of the sewing machine and the pitch in the X-axis direction between the wires 30. That is, according to the machine accuracy of the sewing machine, the minimum needle hole pitch that can be set is about 2 mm. Since one wire 30 is sewn and fastened between adjacent two stitches 43, the maximum needle hole pitch that can be set is about the maximum pitch in the X-axis direction between the wires 30. For example, when the width in the X-axis direction of each element part A1 is about 24 mm and only one wire 30 is included per element part A1 (when the wire group G1 is replaced by one wire 30), the needle hole pitch can be set to be largest, and the needle hole pitch in this case is about 24 mm.

In the example shown in FIG. 3, the needle hole pitch at the position corresponding to the wire 30 is L1, and the needle hole pitch at the position not corresponding to the wire 30 is L2. As described above, the needle hole pitch L1 is set to be as small as possible. The needle hole pitch L2 is set such that the needle holes 21c are provided at an equal distance on the X-axis positive side and the X-axis negative side of each wire 30, for example.

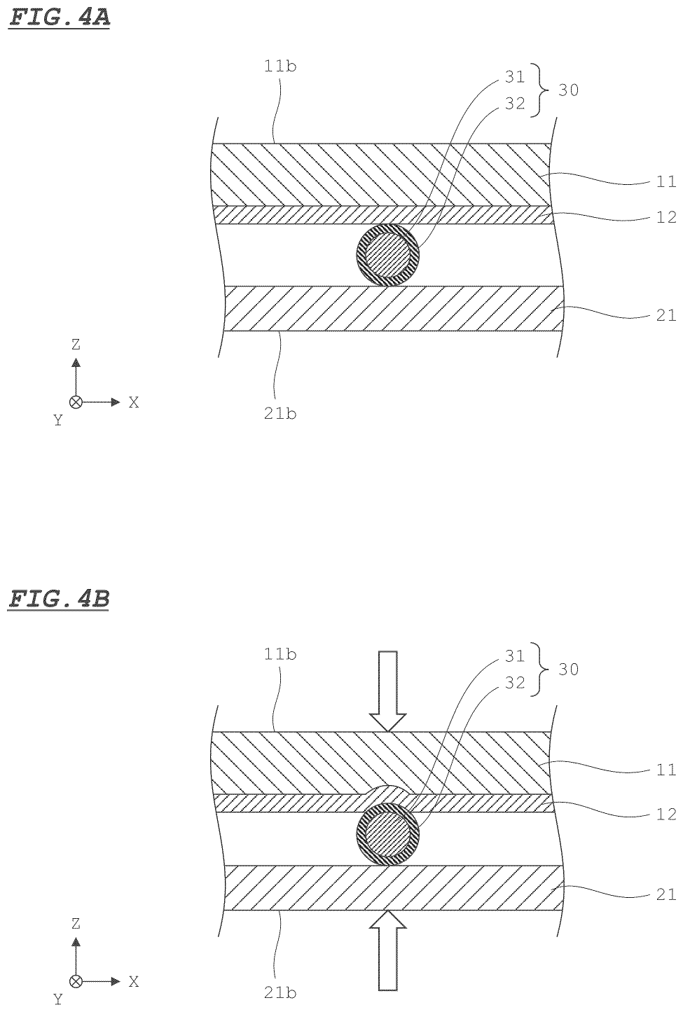

FIGS. 4A, 4B each schematically show a cross section of the vicinity of the crossing position between the electrically-conductive elastic body 12 and the wire 30 along a plane parallel to an X-Z plane at the crossing position.

FIG. 4A shows a state where no load is applied, and FIG. 4B shows a state where loads are applied. In FIGS. 4A, 4B, the lower face 21b on the Z-axis negative side of the second base member 21 is set on the installation surface.

As shown in FIG. 4A, when no load is applied, the force applied between the electrically-conductive elastic body 12 and the wire 30 is substantially zero. From this state, when a load is applied in the downward direction to the upper face 11b of the first base member 11 as shown in FIG. 4B, the electrically-conductive elastic body 12 is deformed by the wire 30.

When loads are applied as shown in FIG. 4B, the wire 30 is brought close to the electrically-conductive elastic body 12 so as to be wrapped by the electrically-conductive elastic body 12, and the contact area between the wire 30 and the electrically-conductive elastic body 12 increases. Accordingly, the capacitance between the conductor wire 31 and the electrically-conductive elastic body 12 changes. Then, the potential reflecting the change in this capacitance is measured by the detection circuit, whereby the load is calculated.

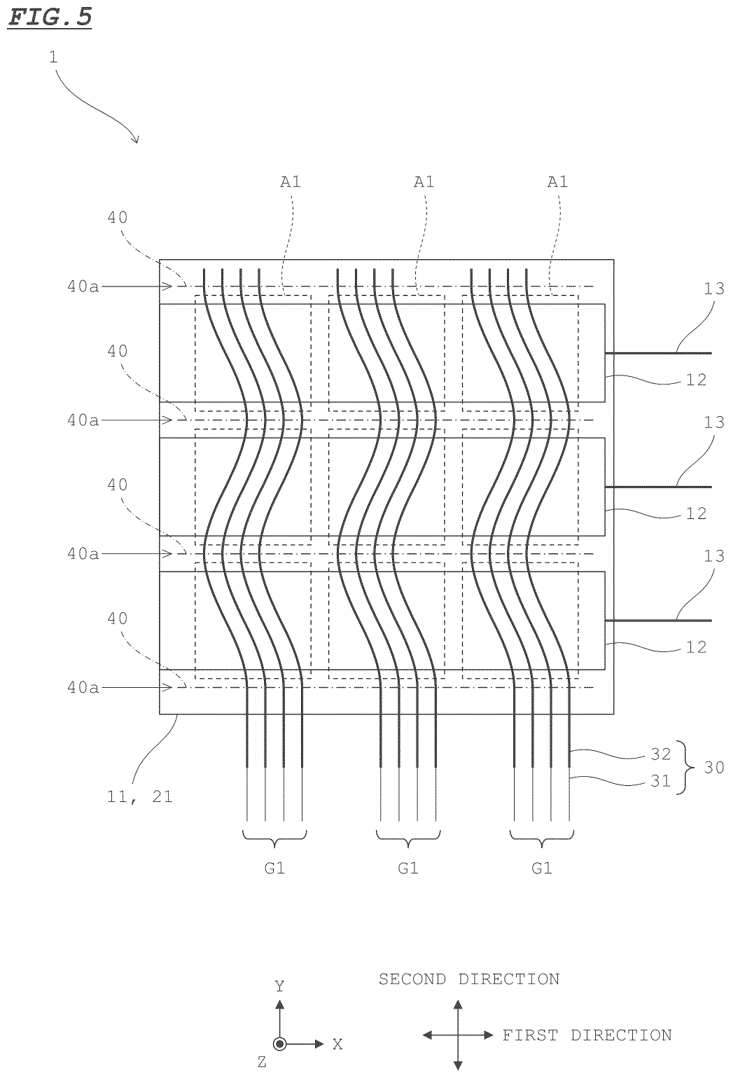

FIG. 5 is a plan view schematically showing a configuration of the inside of the load sensor 1.

Each wire 30 extends in the Y-axis direction and meanders in the X-axis direction, thereby diagonally traversing the element parts A1. Accordingly, the load can be detected in a wide range in each element part A1 and detection sensitivity is enhanced.

A plurality of the stitch rows 40a of the threads 40 are formed, at a predetermined pitch in the Y-axis direction, on the opposing face 21a of the second base member 21. The stitch rows 40a are provided at positions where the stitch rows 40a do not overlap the electrically-conductive elastic bodies 12 in a plan view. Specifically, the stitch rows 40a are provided: between adjacent two electrically-conductive elastic bodies 12; on the outer side in the Y-axis positive direction of the electrically-conductive elastic body 12 on the Y-axis positive side; and on the outer side in the Y-axis negative direction of the electrically-conductive elastic body 12 on the Y-axis negative side.

In one end portion of each wire 30, the covering dielectric body 32 is removed, and the conductor wire 31 is exposed. The exposed conductor wire 31 is connected to the detection circuit (not shown) including a load detection circuit. Accordingly, the three electrically-conductive elastic bodies 12 are connected to the detection circuit. The four conductor wires 31 included in one wire group G1 are connected to each other in the load sensor 1 or the detection circuit.

The detection circuit detects the value of the capacitance for each element part A1 while switching the electrically-conductive elastic body 12 and the wire group G1 serving as the detection target. Specifically, the detection circuit applies a DC voltage via a resistor to the electrically-conductive elastic body 12 and the wire group G1 crossing each other in the element part A1 serving as the detection target, and measures the voltage value at this crossing position. The voltage value at the crossing position increases according to the time constant defined by this resistor and the capacitance (the capacitance between the electrically-conductive elastic body 12 and the four conductor wires 31) at the crossing position.

The capacitance at the crossing position has a magnitude corresponding to the load being applied at the crossing position. That is, in accordance with the load applied at the crossing position, the contact area of the dielectric body 32 with respect to the electrically-conductive elastic body 12 changes. The capacitance at the crossing position has a value corresponding to this contact area. At a predetermined timing after elapse of a certain period from the start of the application of the DC voltage, the detection circuit measures the voltage value at the crossing position, and based on the measured voltage value, acquires the load of the element part Al corresponding to the crossing position. Accordingly, the load in each element part A1 is detected.

Meanwhile, when the thread 40 is sewn to the second base member 21 as described above, the second base member 21 is pulled by the thread 40 at the positions of the stitches 43, whereby the second base member 21 buckles, and due to this buckling, waving in the up-down direction may occur in the second base member 21.

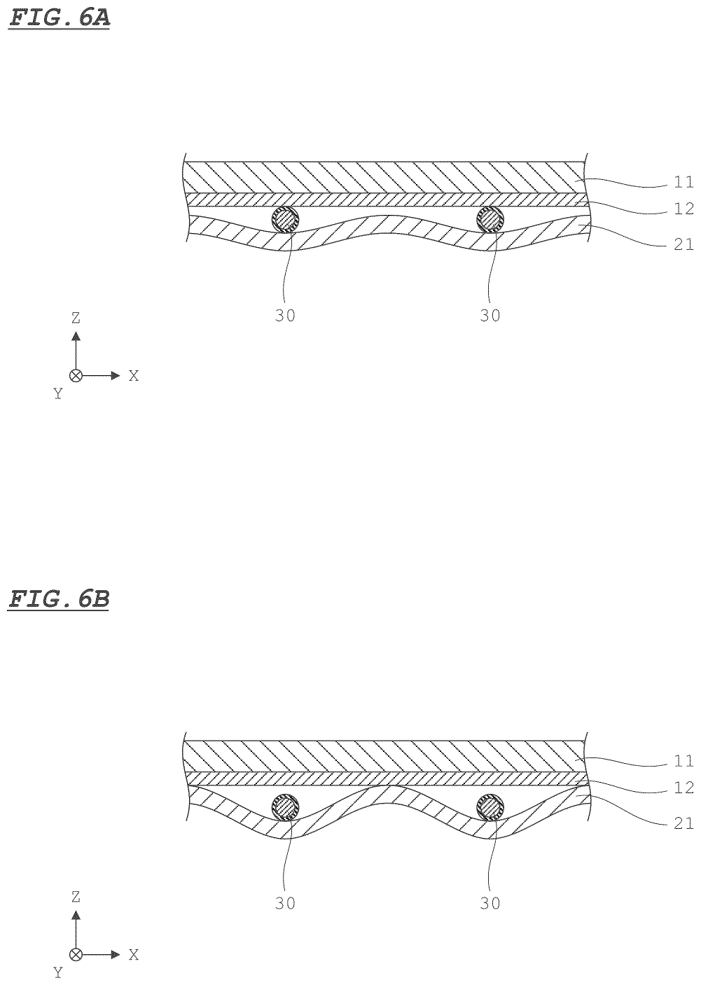

FIGS. 6A, 6B are each a cross-sectional view schematically showing a state where waving has occurred in the second base member 21 due to sewing of the thread 40. FIGS. 6A, 6B each show a cross-sectional view of the load sensor 1 along a plane parallel to an X-Z plane at the crossing position between the electrically-conductive elastic body 12 and the wire 30. For convenience, in FIGS. 6A, 6B, the thread 40 is not shown.

As shown in FIGS. 6A, 6B, when the rigidity of the second base member 21 is low, waving of the second base member 21 may occur due to the tension of the thread 40. In FIG. 6B, as compared with FIG. 6A, the rigidity of the second base member 21 is low, and thus, the waving of the second base member 21 is larger. Thus, when large waving has occurred in the second base member 21, the upper face of the upward waving portion may hit the lower face of the electrically-conductive elastic body 12, whereby the upper end of the wire 30 may be detached from the lower face of the electrically-conductive elastic body 12. In this case, until the load reaches a predetermined value from 0, the second base member 21 in the waving state will support the load, and the wire 30 does not come into contact with the electrically-conductive elastic body 12. Therefore, in the case of FIG. 6B, until the load reaches a predetermined value, the detection value of the load remains 0, and the load cannot be accurately detected.

Thus, depending on the condition, such as the rigidity of the second base member 21, that is related to waving of the second base member 21, waving of the second base member 21 may become large, and the detection accuracy of the load may decrease.

Therefore, the inventors examined how much waving actually occurred, by changing a plurality of parameters related to waving of the second base member 21, and based on the examination result, found a conditional expression including various parameters that allow accurate detection of a load. In the following, a determination criterion as to whether or not a load can be accurately detected, examination regarding waving, and the conditional expression will be described in order.

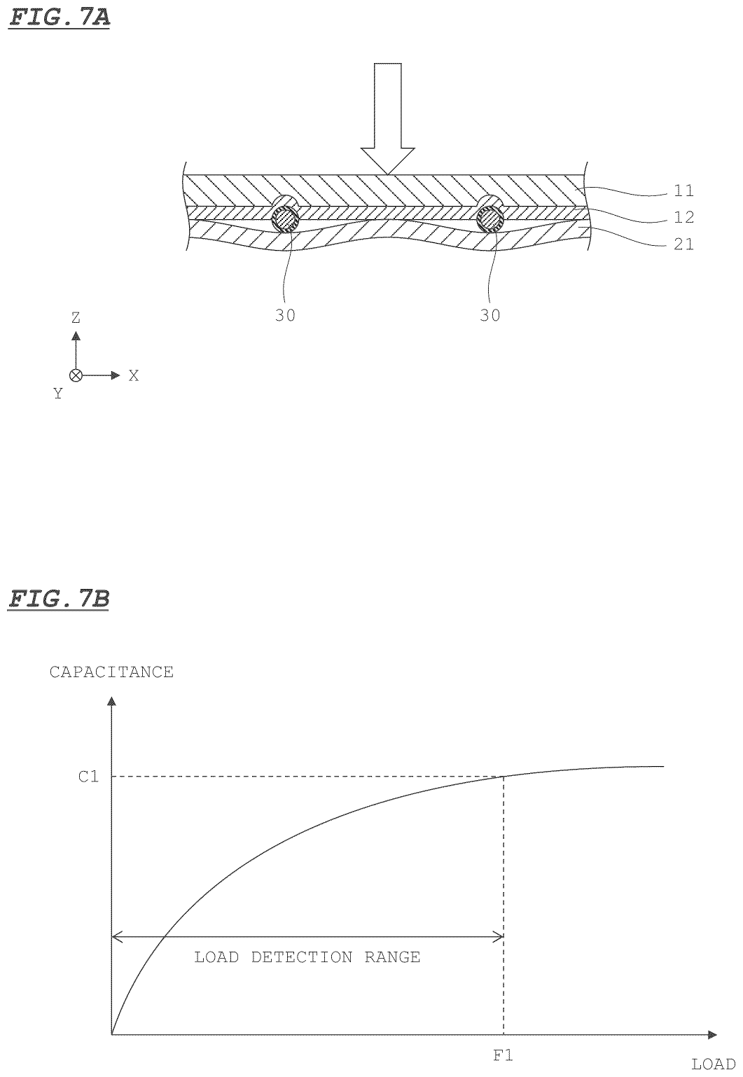

FIGS. 7A, 7B are each a diagram describing a determination criterion as to whether or not a load can be accurately detected. FIG. 7A is a cross-sectional view similar to those in FIGS. 6A, 6B. FIG. 7B is a graph schematically showing a relationship between load and capacitance.

Even in a case where waving of the second base member 21 has occurred due to the thread 40, when a load is applied as shown in FIG. 7A, if the second base member 21 does not come into contact with the electrically-conductive elastic body 12 until the outer periphery of the upper half of the wire 30 is wrapped by the electrically-conductive elastic body 12, the load can be accurately detected.

That is, when the load applied to the first base member 11 gradually increases, the contact area between the electrically-conductive elastic body 12 and the conductor wire 31 via the dielectric body 32 changes while the outer periphery of the upper half of the wire 30 is wrapped by the electrically-conductive elastic body 12, and thereafter, the contact area does not change even if the load is further increased. As described above, the capacitance between the conductor wire 31 and the electrically-conductive elastic body 12 changes in accordance with the contact area. Therefore, the range in which the load can be appropriately detected based on the capacitance is limited to the range of the load until the upper half of the wire 30 is wrapped by the electrically-conductive elastic body 12. Therefore, if the second base member 21 does not come into contact with the electrically-conductive elastic body 12 in this period, it is determined that the load can be accurately detected.

Normally, as shown in FIG. 7B, the range up to a load F1 corresponding to a capacitance C1, which is slightly lower than the saturation value of the capacitance, is set as the load detection range (dynamic range). That is, when the load exceeds F1 (the capacitance is C1), it becomes difficult to accurately detect the load on the basis of the capacitance since change in the capacitance with respect to increase in the load is rather small. Therefore, the load detection range (dynamic range) is set to 0 or more and F1 or less. Therefore, if the second base member 21 does not come into contact with the electrically-conductive elastic body 12 in this range, it is determined that the load serving as the detection target can be appropriately detected.

As described above, whether or not the load can be accurately detected is determined by the methods described with reference to FIGS. 7A, 7B. It is noted that, when a first determination criterion described with reference to FIG. 7A, i.e., that the second base member 21 does not come into contact with the electrically-conductive elastic body 12 in the range of the load until the upper half of the wire 30 is wrapped by the electrically-conductive elastic body 12 (until increase in the contact area is saturated), is satisfied, a second determination criterion described with reference to FIG. 7B, i.e., that the second base member 21 does not come into contact with the electrically-conductive elastic body 12 in the load detection range (dynamic range), is satisfied. Therefore, more broadly, the first determination criterion described with reference to FIG. 7A may be applied.

Next, the examination regarding waving performed by the inventors will be described.

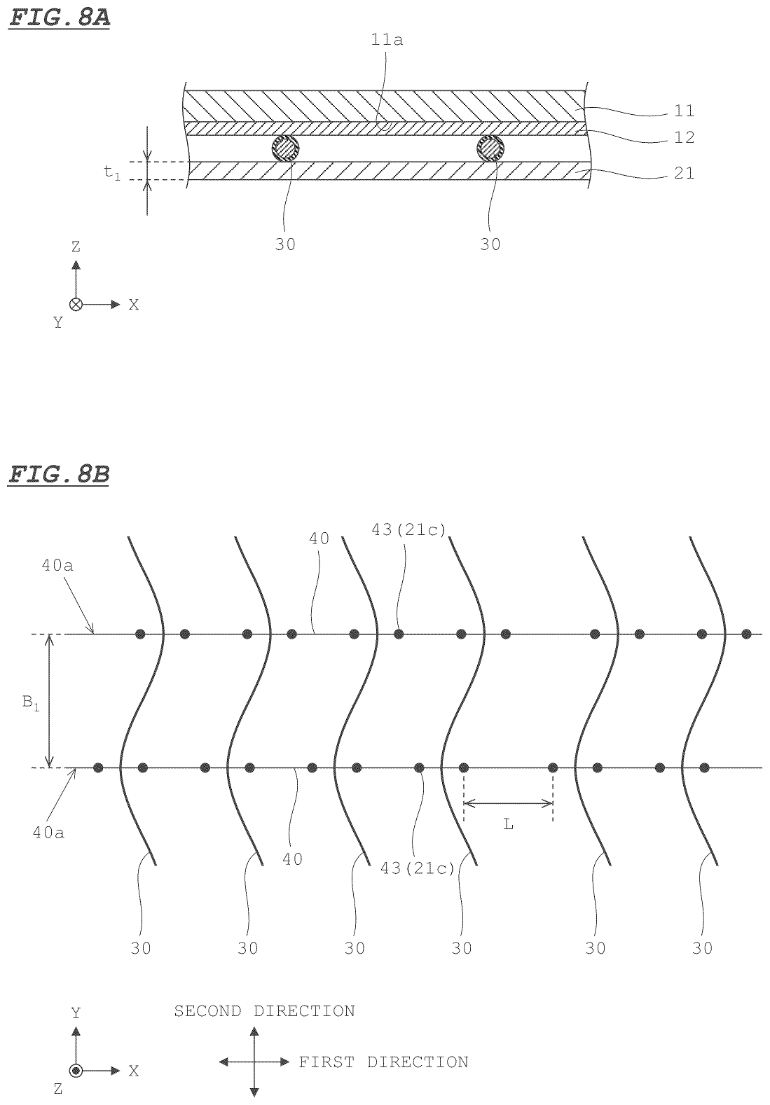

FIGS. 8A, 8B are each a schematic diagram describing a condition of the examination regarding waving. FIG. 8A schematically shows a cross section of the vicinity of the crossing position between the electrically-conductive elastic body 12 and the wire 30 along a plane parallel to an X-Z plane at the crossing position. FIG. 8B is a plan view schematically showing the disposition of the wires 30 and the stitches 43 (needle holes 21c).

As shown in FIG. 8A, in the examination regarding waving, similar to Embodiment 1, the wires 30 were disposed between the first base member 11 and the second base member 21, and the electrically-conductive elastic bodies 12 were disposed on the opposing face 11a of the first base member 11. The number of the wires 30 that were disposed was about several tens. The thickness of the second base member 21 was set to t₁.

In the present examination, the diameter of each wire 30 was set to 0.6 mm. When the diameter of the wire 30 is larger than 0.6 mm, it becomes difficult to: cause the wire 30 to meander in the X-axis direction as shown in FIG. 8B; connect the wire 30 to the detection circuit by bending or the like; replace one wire group G1 by bending one wire 30; and the like. Therefore, in the present examination, assuming a wire 30 usable in an actual load sensor 1, the diameter of the wire 30 was set to 0.6 mm.

As shown in FIG. 8B, in the examination regarding waving, similar to Embodiment 1, the wires 30 were sewn and fastened to the second base member 21 by using the threads 40. At this time, the needle holes 21c were provided at a predetermined pitch in the X-axis direction, the stitches 43 by the needle thread 41 and the bobbin thread 42 (see FIG. 3) were formed at the needle holes 21c, and the stitch rows 40a in each of which the stitches 43 and the thread 40 were aligned in the X-axis direction were formed. Out of the pitches (needle hole pitches) between adjacent two needle holes 21c on the stitch row 40a, the largest needle hole pitch (the longest needle hole pitch) was defined as L. In the case of FIG. 3, this longest needle hole pitch L corresponds to the needle hole pitch L2. The pitch between the plurality of stitch rows 40a was defined as B₁. Other than this, the elastic modulus of the second base member 21 was defined as E₁.

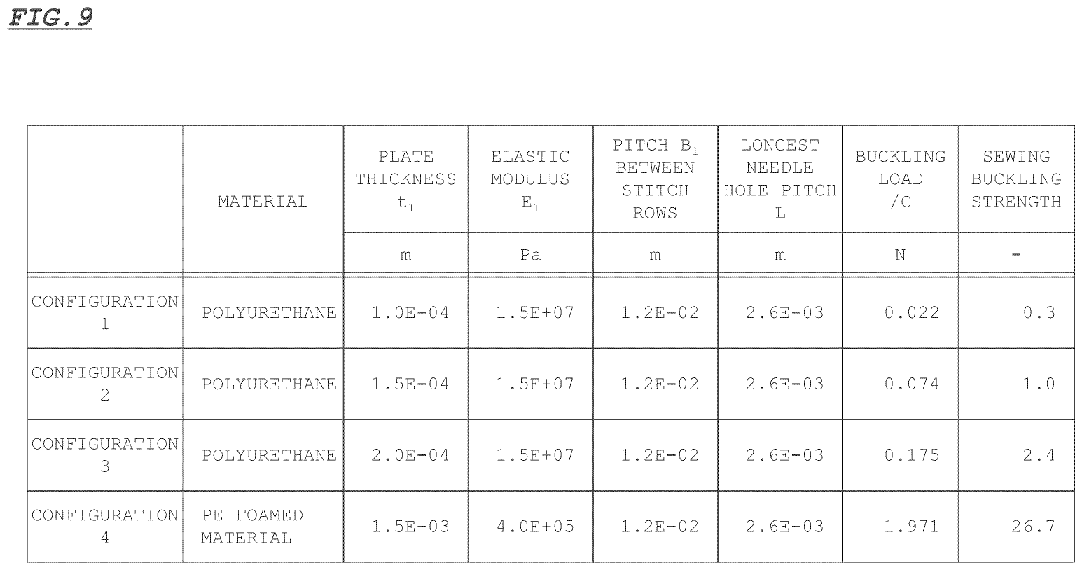

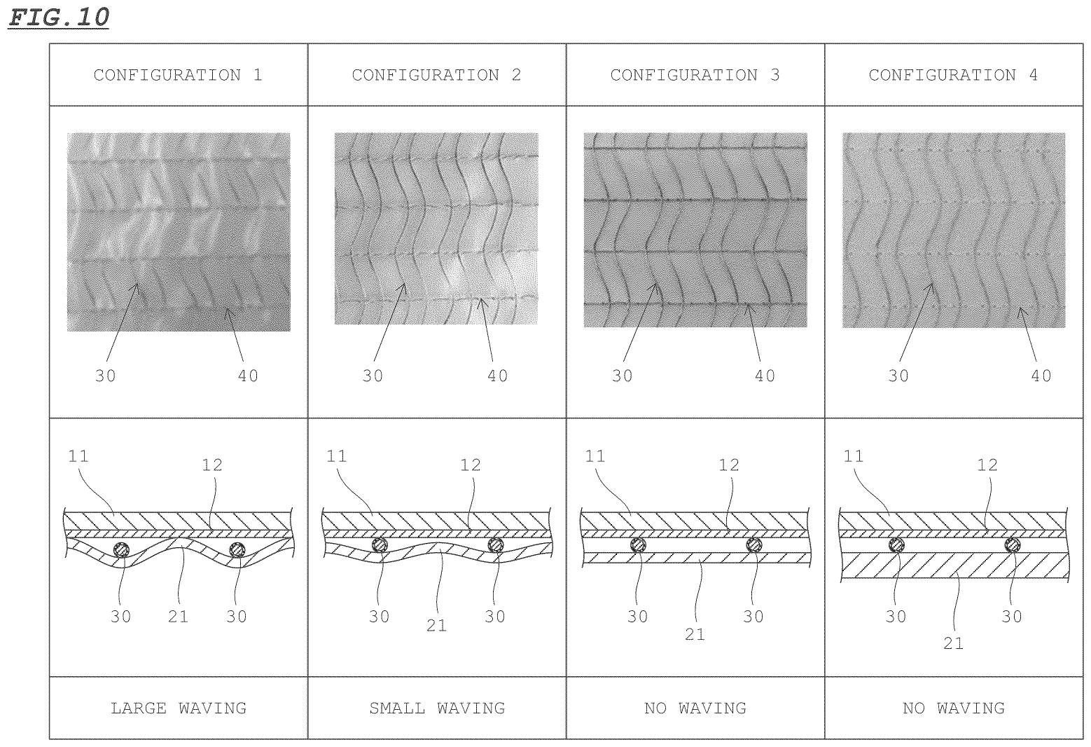

FIG. 9 shows set values and examination results of Configurations 1 to 4 used in the examination regarding waving. FIG. 10 shows actual plan views of Configurations 1 to 4, cross-sectional views schematically showing Configurations 1 to 4, and results of waving states of Configurations 1 to 4.

As shown in FIG. 9, the inventors actually created four Configurations 1 to 4 in each of which the thickness t₁ of the second base member 21, the elastic modulus E₁ of the second base member 21, the pitch B₁ between the stitch rows 40a, and the longest needle hole pitch L were each set to a predetermined value.

The material of Configurations 1 to 3 is polyurethane and the material of Configuration 4 is a PE (polyethylene) foamed material. The thickness t₁ of the second base member 21 of Configuration 1 is 0.1 mm, the thickness t₁ of the second base member 21 of Configuration 2 is 0.15 mm, the thickness t₁ of the second base member 21 of Configuration 3 is 0.2 mm, and the thickness t₁ of the second base member 21 of Configuration 4 is 1.5 mm. The elastic modulus E₁ of the second base member 21 of Configurations 1 to 3 is 15 MPa, and the elastic modulus E₁ of the second base member 21 of Configuration 4 is 0.4 MPa. The pitch B₁ between the stitch rows 40a of Configurations 1 to 4 is 12 mm. The longest needle hole pitch L of Configurations 1 to 4 is 2.6 mm.

The actual plan views obtained by capturing, from the Z-axis positive side, the images of Configurations 1 to 4 created in this manner are as shown in FIG. 10. As shown in the actual plan views in FIG. 10, large waving occurred in Configuration 1, small waving occurred in Configuration 2, and substantially no waving occurred in Configurations 3, 4. FIG. 10 also shows the cross-sectional views and the waving states showing the waving states of Configurations 1 to 4 at this time.

Further, with respect to Configurations 1 to 4, the inventors set the lower face 21b of the second base member 21 on the installation surface, applied a load from the upper face 11b of the first base member 11, and confirmed, according to the first determination criterion shown in FIG. 7A, whether or not the second base member 21 came into contact with the electrically-conductive elastic body 12 in the range of the load until the upper half of the wire 30 was wrapped by the electrically-conductive elastic body 12 (until increase in the contact area was saturated). As described above, if the second base member 21 does not come into contact with the electrically-conductive elastic body 12 in this range, it is determined that the load can be accurately detected. Consequently, it was determined that, in the case of Configuration 1, the load cannot be accurately detected, and in the cases of Configurations 2 to 4, the load can be accurately detected. As for Configuration 2, the waving state was close to that at the limit where the first determination criterion was satisfied.

Here, the inventors considered that Euler's buckling load formula could be used for quantitative evaluation of the waving state of the second base member 21.

That is, in FIG. 8B, between adjacent stitches 43 (needle holes 21c) on the stitch row 40a, tension (force in the shrinking direction) of the thread 40 is applied, and due to this tension, buckling occurs in the region between the stitches 43. Therefore, when this region is assumed to be a column, waving of this region due to buckling can be obtained from Euler's buckling load formula. In this case, a region that has the maximum pitch between adjacent stitches 43 (needle holes 21c) buckles to the greatest extent. Therefore, in order to perform the evaluation according to the above determination criterion, the state of waving based on the buckling may be obtained from Euler's buckling load formula, using the region having the maximum pitch between adjacent stitches 43 (needle holes 21c) as the target. The region assumed to be a column is a rectangular region, of the second base member 21, that has this maximum pitch (L in FIG. 8B) as one side and the pitch (B₁ in FIG. 8B) between adjacent stitch rows 40a as another side. The thickness of this region is the thickness of the second base member 21.

In Euler's buckling load formula, when the coefficient of end condition is defined as C, the elastic modulus of the column member is defined as E, the moment of inertia of area of the column member is defined as I, and the length of the column is defined as L, a buckling load P is represented by Expression (1) below.

$$P = C \frac{{π}^{2} EI}{{L}^{2}} \qquad ( 1 )$$

In a cross section having a rectangular parallelepiped

shape, when the lengths of two sides are defined as b and t, and the length in the direction in which bending occurs is defined as t, the moment of inertia of area is represented by Expression (2) below.

$$I = \frac{{bt}^{3}}{12} \qquad ( 2 )$$

From Formulas (1), (2) above, the buckling load P is represented by Expression (3) below.

$$P = C \frac{{π}^{2} {Ebt}^{3}}{12 {L}^{2}} \qquad ( 3 )$$

When the parameters in Expression (3) are replaced by the parameters used in the examination regarding waving described with reference to FIGS. 8A, 8B, Expression (3) above becomes Expression (4) below.

$$P = \frac{{E}_{1} C}{12} {( \frac{π}{L} )}^{2} {B}_{1} {t}_{1}^{3} \qquad ( 4 )$$

When both sides of Expression (4) above are divided by the coefficient of end condition C, Expression (5) below is acquired.

$$\frac{P}{C} = \frac{{E}_{1}}{12} {( \frac{π}{L} )}^{2} {B}_{1} {t}_{1}^{3} \qquad ( 5 )$$

The inventors considered that when the buckling load P/the coefficient of end condition C of Expression (5) above was calculated with respect to Configurations 1 to 4 above, the waving state (buckling state) of Configurations 1 to 4 could be quantitatively evaluated.

The calculation results of the buckling load P/the coefficient of end condition C are as shown in FIG. 9. The value of the buckling load P/the coefficient of end condition C was 0.022 N in Configuration 1, 0.074 N in Configuration 2, 0.175 N in Configuration 3, and 1.971 N in Configuration 4.

As described above, out of Configurations 1 to 4, those with which the load could be accurately detected were Configurations 2 to 4. Therefore, if the value of the buckling load P/the coefficient of end condition C is 0.074 N or more, which was of Configuration 2 and which was close to the limit of the determination criterion above, it is estimated that the load can be appropriately detected. Here, when the right side of Expression (5) above is multiplied by 1/0.074 (=13.5), the value of (the buckling load P/the coefficient of end condition C)×13.5 in the case of Configuration 2 can be normalized to 1.0. Multiplying the right side of Expression (5) above by 13.5 is the same as setting the coefficient of end condition C to 13.5 in Expression (4) above.

Thus, from the relationship with the diameter of the wire 30 to be used, the coefficient of end condition C may be set close to the maximum value of the reciprocal of the value of the buckling load P/the coefficient of end condition C above when the second base member 21 (target base member) does not support the load at least in the load detection range. Therefore, when the coefficient of end condition C is set to 13.5, if the relational expression (6) below is satisfied, waving of the second base member 21 is suppressed, and thus, it is possible to estimate that the load can be accurately detected.

$$1. ≦ \frac{{E}_{1} C}{12} {( \frac{π}{L} )}^{2} {B}_{1} {t}_{1}^{3} \qquad ( 6 )$$

The value (the value of sewing buckling strength) on the right side of Expression (6) above when the coefficient of end condition C was set to 13.5 is as shown in FIG. 9. The value of the sewing buckling strength was 0.3 in Configuration 1, 1.0 in Configuration 2, 2.4 in Configuration 3, and 26.7 in Configuration 4. In the case of Configuration 1, Expression (6) above is not satisfied, and this result matches the result actually confirmed in the examination regarding waving. In the cases of Configurations 2 to 4, Expression (6) above is satisfied, and this result matches the results actually confirmed in the examination regarding waving. Therefore, Expression (6) above can be used as a conditional expression for suppressing waving of the second base member 21 so as to allow appropriate detection of the load.

### Effects of Embodiment 1

According to Embodiment 1, the following effects are exhibited.

Each thread 40 is sewn to the second base member 21 (target base member) such that waving that supports the load does not occur, at least in the load detection range (see FIG. 7), in the second base member 21 (target base member) to which a plurality of the conductor wires 31 are sewn and fastened. Accordingly, waving that supports the load is suppressed from occurring in the second base member 21. That is, waving in which the second base member 21 (target base member) comes into contact with the electrically-conductive elastic body 12 and the first base member 11 on the first base member 11 (another base member) side is suppressed. Therefore, the applied load can be accurately detected.

As shown by the examination regarding waving in FIG. 8A to FIG. 10, when Expression (6) above is satisfied, waving of the second base member 21 is appropriately suppressed. Accordingly, the second base member 21 is suppressed from supporting a part of the load applied to the load sensor 1, and the load can be accurately detected.

As shown in FIG. 5, the stitch rows 40a are provided at positions where the stitch rows 40a do not overlap the electrically-conductive elastic bodies 12 in a plan view. With this configuration, since the stitch rows 40a do not overlap the electrically-conductive elastic bodies 12, influence of the stitch rows 40a on the load detection can be suppressed. Therefore, the load can be accurately detected.

Thus, when the stitch rows 40a are provided at positions where the stitch rows 40a do not overlap the electrically-conductive elastic bodies 12 in a plan view, it is preferable that the pitch B₁ between the plurality of stitch rows 40a is 3 mm or more and 26 mm or less.

That is, according to the printing accuracy, there is a possibility that the electrically-conductive elastic body 12 may be displaced by about 1 mm in the Y-axis positive and negative directions. Therefore, the interval (the distance between the boundaries of the needle holes 21c) of the needle holes 21c needs to be 2 mm or more. Therefore, when the diameter of the needle of the sewing machine is about 1 mm, it is preferable that the pitch B₁ between the stitch rows 40a is 3 mm or more. When the pitch in the Y-axis direction of the element parts A1 becomes large, one element part A1 becomes large. In this case, in association with increase in the area of the element part A1 resolution of the load detection decreases, and thus, it becomes difficult to understand the shape and the load distribution of an object that is on the load sensor 1. In contrast, when the pitch B₁ is set to 26 mm or less, a case where the pitch of the element part A1 is 1 inch (25.4 mm) can also be coped with, and the shape and the load distribution of the object can be detected in a unit of substantially 1 inch. When the pitch B₁ is set to be in the above range as well, if each value is set such that Expression (6) above is satisfied, waving of the second base member 21 can be appropriately suppressed, and the load can be accurately detected.

As described with reference to FIG. 3, the minimum needle hole pitch (the pitch in the X-axis direction between the needle holes 21c) that can be set is about 2 mm, and the maximum needle hole pitch that can be set is about 24 mm. Therefore, it is preferable that the maximum needle hole pitch (the longest needle hole pitch L) out of the needle hole pitches of the thread 40 on the stitch row 40a is 2 mm or more and 24 mm or less. When the longest needle hole pitch L is set to be in the above range as well, if each value is set such that Expression (6) above is satisfied, waving of the second base member 21 can be appropriately suppressed, and the load can be accurately detected.

The elastic modulus of the first base member 11 is preferably 1 MPa or more and 3 MPa or less. The elastic modulus of 1 MPa or more and 3 MPa or less corresponds to a hardness of about A50°. When the elastic modulus of the first base member 11 is set in this manner, good balance of parameters related to load detection characteristics such as elastic deformation (detection sensitivity) of the first base member 11 during load application and restoration of the first base member 11 due to impact resilience during load release, is maintained. Accordingly, the load can be stably detected.

The thickness of the first base member 11 is preferably 0.02 mm or more and 1 mm or less. When a load is applied, the wire 30 sinks in the first base member 11 and the first base member 11 is compressed. Due to this compression, the thickness of the first base member 11 can be reduced by a maximum of the diameter of the wire 30. Therefore, if the thickness of the first base member 11 is smaller than the diameter of the wire 30, there is a risk that excessive distortion is caused at the compression position, resulting in breakage of the first base member 11. Therefore, it is preferable that the thickness of the first base member 11 is equal to or larger than the diameter of the wire 30. The minimum value of the diameter of the wire 30 (conductor wire 31) according to the JIS is 0.02 mm.

Therefore, the thickness of the first base member 11 may be set to 0.02 mm or more. On the other hand, the larger the thickness of the first base member 11 is, the higher the material cost of the first base member 11 becomes. Therefore, from the viewpoint of suppressing the material cost, it is preferable that the thickness of the first base member 11 is set to 1 mm or less.

It is preferable that the elastic modulus of the electrically-conductive elastic body 12 is smaller than the elastic modulus of the first base member 11 and is 0.5 MPa or more and 3 MPa or less. Accordingly, during load application, the electrically-conductive elastic body 12 is elastically deformed in a preferable manner, and the contact area between the wire 30 and the electrically-conductive elastic body 12 smoothly changes.

The dielectric body 32 is set so as to cover the surface of the conductor wire 31. With this configuration, the dielectric body 32 can be disposed between the electrically-conductive elastic body 12 and the conductor wire 31 by merely covering the surface of the conductor wire 31 with the dielectric body 32.

### Embodiment 2

In Embodiment 1, the wires 30 are sewn to the second base member 21 on which the electrically-conductive elastic bodies 12 are not disposed. In contrast, in Embodiment 2, the wires 30 are sewn to the first base member 11 on which the electrically-conductive elastic bodies 12 are disposed.

In the following, in Embodiment 2, components denoted by the same reference characters as those in Embodiment 1 are configured in the same manner as in Embodiment 1 unless otherwise specified.

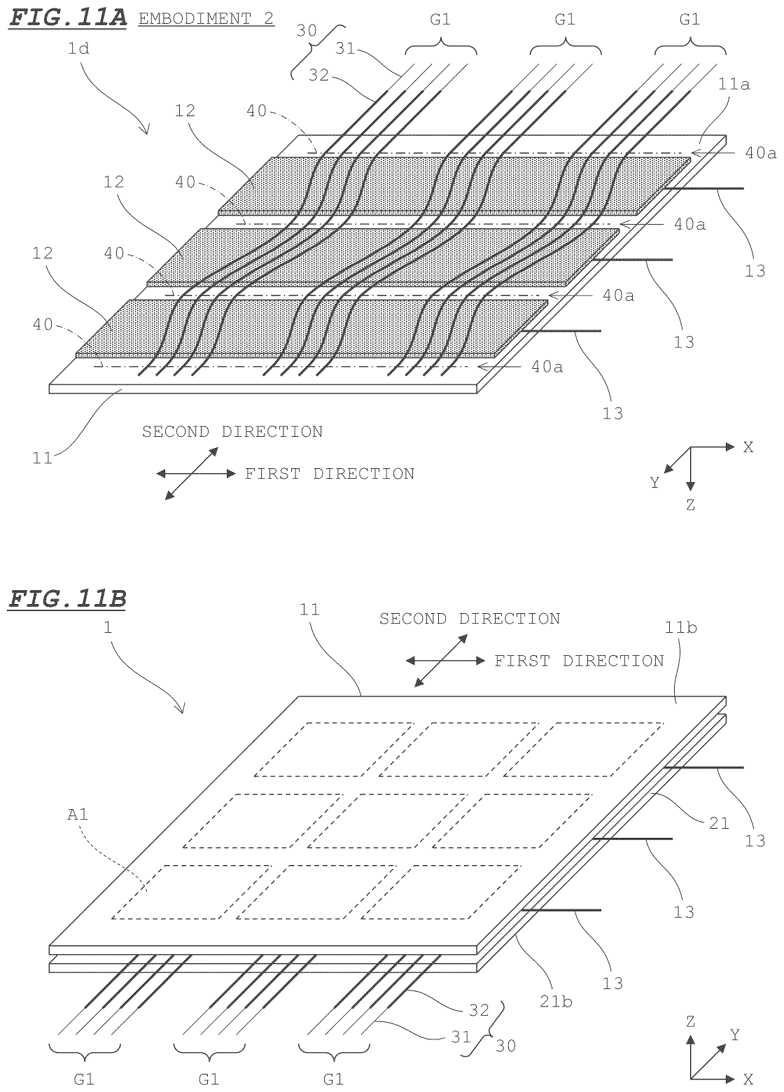

FIG. 11A schematically shows a configuration of a structure 1d in a manufacturing step according to Embodiment 2.

In the structure 1d, the wires 30 are sewn to the structure 1a in FIG. 1A by the threads 40.

Each wire 30 is sewn and fastened to the opposing face 11a of the first base member 11 by the threads 40. The stitch row 40a of each thread 40 extends in the X-axis direction (the first direction) as in Embodiment 1. On the stitch row 40a, the thread 40 sews and fastens, across all of the wires 30, each wire 30 to the first base member 11. In FIG. 11A, four stitch rows 40a of the threads 40 are provided to the first base member 11. When the load sensor 1 has been completed, in a plan view, the stitch rows 40a of Embodiment 2 are disposed at positions where the stitch rows 40a do not overlap the electrically-conductive elastic bodies 12, as in Embodiment 1.

FIG. 11B is a perspective view schematically showing a configuration of the load sensor 1 according to Embodiment 2.

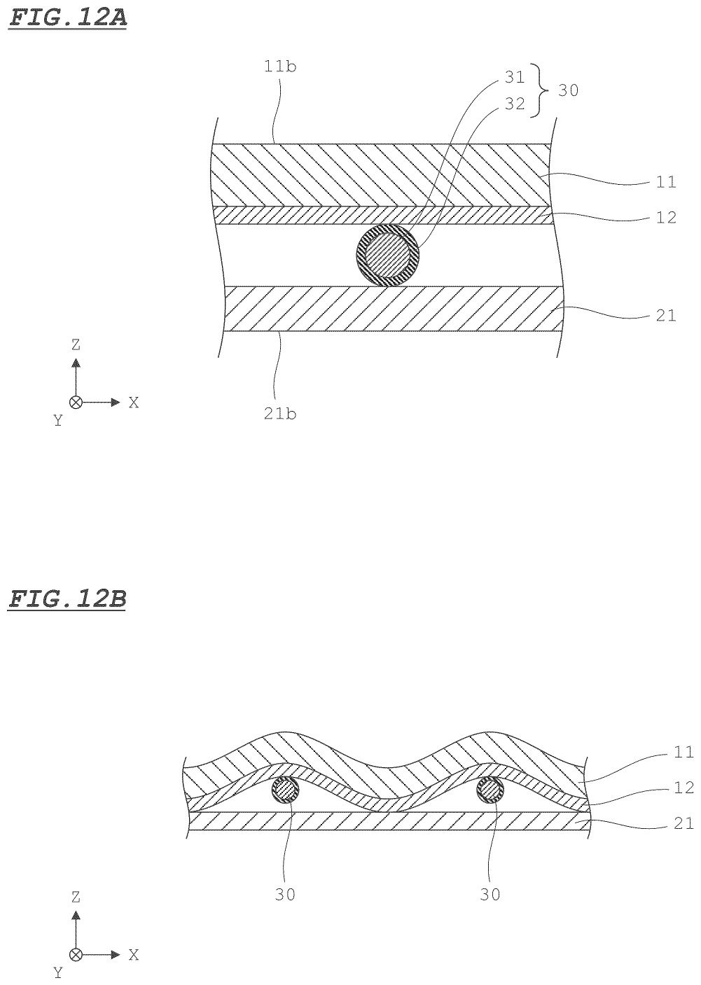

The structure 1d in FIG. 11A is superposed with its front face and back face reversed, from above (on the Z-axis positive side) the second base member 21 which is similar to that in Embodiment 1 shown in FIG. 1B. Then, the outer periphery of the first base member 11 is connected by a thread (not shown) to the second base member 21, whereby the first base member 11 is fixed to the second base member 21. Then, the load sensor 1 is completed as shown in FIG. 12B.

The load sensor 1 of Embodiment 2 is also used in a state where the first base member 11 is oriented to the upper side (the Z-axis positive side) and the second base member 21 is oriented to the lower side (the Z-axis negative side). In this case as well, the upper face 11b of the first base member 11 serves as the face to which a load is applied, and the lower face 21b of the second base member 21 is set on an installation surface. In Embodiment 2 as well, the cross section of the vicinity of the crossing position between the electrically-conductive elastic body 12 and the wire 30 along a plane parallel to an X-Z plane at the crossing position is in the state shown in FIG. 12A, similar to Embodiment 1.

In Embodiment 2, a plurality of the wires 30 are sewn and fastened to the first base member 11 by the threads 40.

Therefore, as shown in FIG. 12B, waving of the first base member 11 may occur due to the tension of the thread 40. In this case, if the waving portion of the first base member 11 (target base member), directly or via the electrically-conductive elastic body 12, comes into contact with the second base member 21 during load application, the first base member 11 will support the load. Therefore, in Embodiment 2, the plurality of the wires 30 may be sewn and fastened to the first base member 11 by the threads 40 such that the first base member 11 does not come into contact with the second base member 21 at least in the load detection range.

Here, the inventors considered that the conditional expression (6), shown in Embodiment 1, for suppressing waving of the second base member 21 to which the wires 30 were sewn could be applied to Embodiment 2 as well. That is, similar to the conditional expression (6) of Embodiment 1, in Embodiment 2 as well, the inventors considered that a conditional expression for suppressing waving of the first base member 11 to which the wires 30 were sewn could be derived. However, in Embodiment 2, since the electrically-conductive elastic bodies 12 are formed on the opposing face 11a of the first base member 11 to which the wires 30 are sewn, it is necessary to transform the conditional expression (6) in consideration of influence of the electrically-conductive elastic bodies 12.

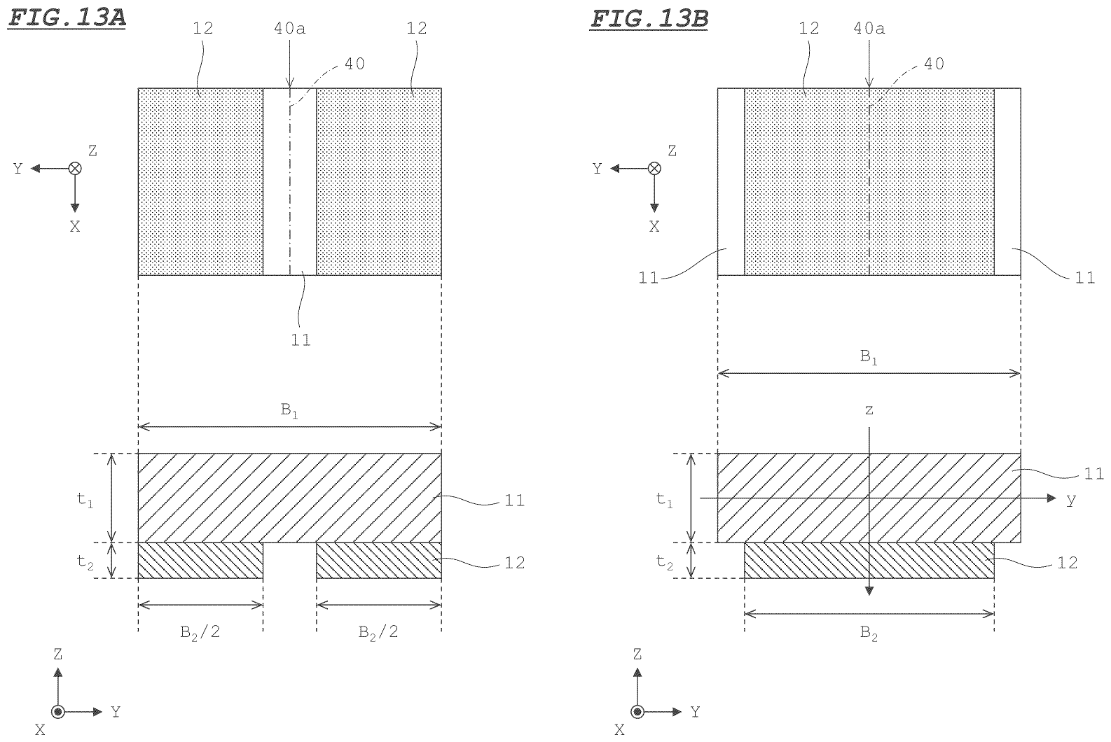

FIG. 13A is a plan view and a cross-sectional view schematically showing the vicinity of the gap between two electrically-conductive elastic bodies 12 adjacent to each other in the Y-axis direction.

FIG. 13A shows a portion from the center in the Y-axis direction of one electrically-conductive elastic body 12 to the center in the Y-axis direction of another electrically-conductive elastic body 12 adjacent to the one electrically-conductive elastic body 12. The thickness of the first base member 11 is defined as t₁, and the pitch (the width in the Y-axis direction of the structure in FIG. 13A) of the stitch row 40a of the thread 40 is defined as B₁. The thickness of the electrically-conductive elastic body 12 is defined as t₂, and the width in the Y-axis direction of the electrically-conductive elastic body 12 is defined as B₂.

In FIG. 13A, the electrically-conductive elastic bodies 12 are disposed in a symmetrical manner in the Y-axis direction with the stitch row 40a therebetween. However, for convenience, when the electrically-conductive elastic bodies 12 shown in FIG. 13A are joined together at the stitch row 40a, the structure in FIG. 13A becomes the one shown in FIG. 13B. Accordingly, the moment of inertia of area of the structure shown in FIG. 13A becomes equal to the moment of inertia of area of the structure shown in FIG. 13B.

Therefore, a moment of inertia of area I of the structure shown in FIG. 13A can be calculated by Expression (7) below with reference to FIG. 13B. In FIG. 13B, the y-axis is an axis extending in the Y-axis positive direction, and the z-axis is an axis extending in the Z-axis negative direction. The origin of the y-axis and the origin of the z-axis are the center of the first base member 11 included in the structure in FIG. 13B.

$$I = 2 {\int }_{0}^{\frac{{t}_{1}}{2}} {z}^{2} {B}_{1} dz + {\int }_{\frac{{t}_{1}}{2}}^{\frac{{t}_{1}}{2} + {t}_{2}} {z}^{2} {B}_{2} dz \qquad ( 7 )$$

When Expression (7) above is transformed, Expression (8) below is derived.

$$I = \frac{1}{12} \{ {B}_{1} {t}_{1}^{3} + {B}_{2} ( 4 {t}_{2}^{3} + 6 {t}_{1} {t}_{2}^{2} + 3 {t}_{1}^{2} {t}_{2} ) \} \qquad ( 8 )$$

Subsequently, the right side of Expression (8) above is substituted into the moment of inertia of area I of Expression (1) above shown in Embodiment 1. At this time, the term of the coefficient B₁ in Expression (8) above is a term related to the first base member 11, and the term of the coefficient B₂ in Expression (8) above is a term related to the electrically-conductive elastic body 12. Therefore, in Expression (8) above, the term related to the first base member 11 is multiplied by the elastic modulus E₁ of the first base member 11, and the term related to the electrically-conductive elastic body 12 is multiplied by the elastic modulus E₂ of the electrically-conductive elastic body 12. Accordingly, Expression (9) below is derived.

$$P = \frac{C}{12} {( \frac{π}{L} )}^{2} \{ {E}_{1} {B}_{1} {t}_{1}^{3} + {E}_{2} {B}_{2} ( 4 {t}_{2}^{3} + 6 {t}_{1} {t}_{2}^{2} + 3 {t}_{1}^{2} {t}_{2} ) \} \qquad ( 9 )$$

Here, when the thickness t₂ of the electrically-conductive elastic body 12 is set to 0 in Expression (9) above, Expression (9) above needs to be the same as Expression (4) shown in Embodiment 1. In Expression (9) above in which the thickness t₂ is set to 0, the buckling load P on the left side is the same as the buckling load P on the left side of Expression (4) shown in Embodiment 1. Therefore, the coefficient of end condition C in Expression (9) above has the same value (13.5) as the coefficient of end condition C obtained in Embodiment 1.

Therefore, if the relational Expression (10) below is satisfied when the coefficient of end condition is set to 13.5 as in Embodiment 1 above, waving of the first base member 11 is suppressed, and the load can be accurately detected.

$$1. ≦ \frac{C}{12} {( \frac{π}{L} )}^{2} \{ {E}_{1} {B}_{1} {t}_{1}^{3} + {E}_{2} {B}_{2} ( 4 {t}_{2}^{3} + 6 {t}_{1} {t}_{2}^{2} + 3 {t}_{1}^{2} {t}_{2} ) \} \qquad ( 10 )$$

### Effects of Embodiment 2

In Embodiment 2 as well, each thread 40 is sewn to the first base member 11 (target base member) such that waving that supports the load does not occur, at least in the load detection range (see FIG. 7), in the first base member 11 (target base member) to which a plurality of the conductor wires 31 are sewn and fastened. Accordingly, waving that supports the load is suppressed from occurring in the first base member 11. That is, waving in which the first base member 11 and the electrically-conductive elastic body 12 on the first base member 11 (target base member) side come into contact with the opposing second base member 21 (another base member) is suppressed. Therefore, the applied load can be accurately detected.

When Expression (10) above is satisfied, waving of the first base member 11 is appropriately suppressed. Accordingly, the first base member 11 is suppressed from supporting a part of the load applied to the load sensor 1, and the load can be accurately detected.

### Modification

In Embodiments 1, 2 above, the electrically-conductive elastic bodies are disposed on either one of the first base member 11 and the second base member 21. However, the electrically-conductive elastic bodies may be disposed on both of the first base member 11 and the second base member 21. At this time, as in Embodiment 2 above, when Expression (10) above is satisfied, waving of the target base member to which the wires 30 are sewn can be appropriately suppressed.

In Embodiments 1, 2 above, the dielectric body 32 is set so as to cover the entire periphery of the conductor wire 31. However, the dielectric body 32 may be disposed so as to cover at least, out of the surface of the conductor wire 31, only the range in which the contact area changes in accordance with the load. Although the dielectric body 32 is formed from one type of material in the thickness direction, the dielectric body 32 may have a structure in which two types or more of materials are stacked in the thickness direction.

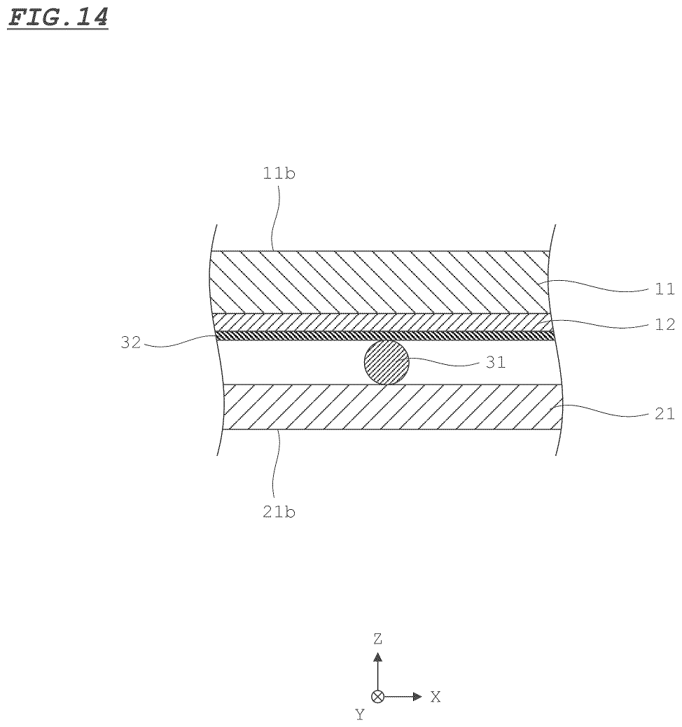

In Embodiments 1, 2 above, the dielectric body 32 is disposed on the surface of the conductor wire 31. However, the dielectric body 32, which defines the capacitance between the conductor wire 31 and the electrically-conductive elastic body 12, may be disposed between the conductor wire 31 and the electrically-conductive elastic body 12. For example, the dielectric body 32 may be disposed on the surface of the electrically-conductive elastic body 12. Specifically, in the configurations of Embodiments 1, 2, the dielectric body 32 may be formed on the surface of the electrically-conductive elastic body 12 as shown in FIG. 14. In this case, the dielectric body 32 is formed from a material that can be elastically deformed so that the contact area with the conductor wire 31 changes in accordance with the load. For example, the dielectric body 32 is formed from a material having an elastic modulus similar to that of the electrically-conductive elastic body 12.

Even in the case where the dielectric body 32 is disposed on the surface of the electrically-conductive elastic body 12 as in FIG. 14, when the base member to which the wires 30 are sewn is the second base member 21, if Expression (6) above is satisfied, waving of the second base member 21 can be appropriately suppressed, as in Embodiment 1 above. On the other hand, when the base member to which the wires 30 are sewn is the first base member 11, waving of the first base member 11 involves the first base member 11, the electrically-conductive elastic body 12, and the dielectric body 32. In this case, when the thickness of the dielectric body 32 is defined as t₃, and the elastic modulus of the dielectric body 32 is defined as E₃, the buckling load P can be represented by Expression (11) below.

$$P = \frac{C}{12} {( \frac{π}{L} )}^{2} [ {E}_{1} {B}_{1} {t}_{1}^{3} + {E}_{2} {B}_{2} ( 4 {t}_{2}^{3} + 6 {t}_{1} {t}_{2}^{2} + 3 {t}_{1}^{2} {t}_{2} ) + {E}_{3} {B}_{2} \{ 4 {t}_{3}^{3} + 6 ( {t}_{1} + 2 {t}_{2} ) {t}_{3}^{2} + 3 {( {t}_{1} + 2 {t}_{2} )}^{2} {t}_{3} \} ] \qquad ( 11 )$$

In this case as well, when the coefficient of end condition is set to 13.5 as in Embodiment 1, if the relational expression (12) below is satisfied, waving of the first base member 11 is suppressed, and the load can be accurately detected.

$$1. ≦ \frac{C}{12} {( \frac{π}{L} )}^{2} [ {E}_{1} {B}_{1} {t}_{1}^{3} + {E}_{2} {B}_{2} ( 4 {t}_{2}^{3} + 6 {t}_{1} {t}_{2}^{2} + 3 {t}_{1}^{2} {t}_{2} ) + {E}_{3} {B}_{2} \{ 4 {t}_{3}^{3} + 6 ( {t}_{1} + 2 {t}_{2} ) {t}_{3}^{2} + 3 {( {t}_{1} + 2 {t}_{2} )}^{2} {t}_{3} \} ] \qquad ( 12 )$$

In Embodiments 1, 2 above, the cross-sectional shape of the conductor wire 31 is a circle, but the cross-sectional shape of the conductor wire 31 is not limited to a circle, and may be another shape such as an ellipse or a pseudo circle. In this case as well, each thread 40 is sewn to the target base member such that waving that supports the load does not occur, at least in the load detection range, in the base member (target base member) to which the wires 30 are sewn. Accordingly, the applied load can be accurately detected.

In Embodiments 1, 2 above, each wire 30 extends in the Y-axis direction (the second direction) while meandering in the X-axis direction (the first direction). However not limited thereto, the wire 30 may extend in a straight line shape in the Y-axis direction (the second direction).

In Embodiments 1, 2 above, three wire groups G1 each corresponding to one element part A1 are disposed, and each wire group G1 includes four wires 30. However, the numbers of the wire groups G1 and the wires 30 are not limited thereto. For example, one, two, four, or more wire groups G1 may be disposed, and one wire group G1 may include one to three, or 5 or more wires 30.

In Embodiments 1, 2 above, three electrically-conductive elastic bodies 12 are disposed. However, the number of the electrically-conductive elastic bodies 12 disposed in the load sensor 1 is not limited thereto. For example, one, two, four, or more electrically-conductive elastic bodies 12 may be disposed.

In Embodiments 1, 2 above, the method of disposing the electrically-conductive elastic bodies 12 on the opposing face 11a of the first base member 11 is not necessarily limited to printing, and another method such as adhering a foil may be adopted.

In Embodiments 1, 2 above, the first direction and the second direction are orthogonal to each other. However, not limited thereto, the angle between the first direction and the second direction may be an angle other than 90°. That is, the first direction and the second direction may diagonally cross each other.

In Embodiments 1, 2 above, the width of the electrically-conductive elastic body 12 need not necessarily be constant. For example, in the ranges between the element parts A1 in the first direction, the width of the electrically-conductive elastic body 12 may be reduced. Further, an electric conductor having a resistance value lower than that of the electrically-conductive elastic body 12 may be formed along the first direction between the first base member 11 and the electrically-conductive elastic body 12. In this case, the electric conductor may have elasticity. For example, similar to the electrically-conductive elastic body 12, the electric conductor can be formed by an electrically-conductive filler (e.g., silver) being dispersed in a resin material or a rubber material. In this configuration, the “electrically-conductive elastic body” described in the claims is composed of the electrically-conductive elastic body 12 and the electric conductor. In this case, in the ranges between the element parts A1 in the first direction, the electrically-conductive elastic body 12 may be omitted, and in these ranges, only the electric conductor may remain.

In addition to the above, various modifications can be made as appropriate to the embodiments of the present invention without departing from the scope of the technical idea defined by the claims.

What is claimed is:

1. A load sensor comprising:
a first base member;
a second base member disposed so as to oppose the first base member;
a plurality of electrically-conductive elastic bodies formed so as to extend in a first direction on an opposing face of the first base member;
a plurality of conductor wires extending in a second direction crossing the first direction, the plurality of conductor wires being disposed so as to be arranged between the first base member and the second base member;
a dielectric body disposed between the electrically-conductive elastic body and the conductor wire; and
a thread configured to sew and fasten the plurality of conductor wires to the first base member or the second base member, wherein
a plurality of stitch rows, of the thread, in each of which stitches are arranged in the first direction are formed at a predetermined pitch in the second direction,
the conductor wire is sewn and fastened to a target base member by the thread in a predetermined space between the stitches adjacent to each other on each of the stitch rows, and
the thread is sewn to the target base member such that waving that supports a load does not occur, at least in a load detection range, in the target base member.

2. The load sensor according to claim 1, wherein
the plurality of conductor wires are sewn and fastened to the second base member, and
when a thickness of the second base member is defined as t₁, an elastic modulus of the second base member is defined as E₁, the pitch between the plurality of stitch rows is defined as B₁, a longest needle hole pitch of the thread on the stitch row is defined as L, and a coefficient of end condition C is defined as 13.5, the thickness t₁, the elastic modulus E₁, the pitch B₁, and the longest needle hole pitch L satisfy a relational expression below.
$$1. ≦ \frac{{E}_{1} C}{12} {( \frac{π}{L} )}^{2} {B}_{1} {t}_{1}^{3}$$

3. The load sensor according to claim 1, wherein
the plurality of conductor wires are sewn and fastened to the first base member, and
when a thickness of the first base member is defined as t₁, an elastic modulus of the first base member is defined as E₁, a thickness of the electrically-conductive elastic body is defined as t₂, an elastic modulus of the electrically-conductive elastic body is defined as E₂, the pitch between the plurality of stitch rows is defined as B₁, a width of the electrically-conductive elastic body in the second direction is defined as B₂, a longest needle hole pitch of the thread on the stitch row is defined as L, and a coefficient of end condition C is defined as 13.5, the thicknesses t₁, t₂, the elastic moduli E₁, E₂, the pitch B₁, the width B₂, and the longest needle hole pitch L satisfy a relational expression below.
$$1. ≦ \frac{C}{12} {( \frac{π}{L} )}^{2} \{ {E}_{1} {B}_{1} {t}_{1}^{3} + {E}_{2} {B}_{2} ( 4 {t}_{2}^{3} + 6 {t}_{1} {t}_{2}^{2} + 3 {t}_{1}^{2} {t}_{2} ) \}$$

4. The load sensor according to claim 1, wherein
the stitch rows are provided at positions where the stitch rows do not overlap the electrically-conductive elastic bodies in a plan view.

5. The load sensor according to claim 1, wherein
the pitch between the plurality of stitch rows is 3 mm or more and 26 mm or less.

6. The load sensor according to claim 1, wherein
a longest needle hole pitch L of the thread is 2 mm or more and 24 mm or less.

7. The load sensor according to claim 1, wherein
an elastic modulus of the first base member is 1 MPa or more and 3 MPa or less.

8. The load sensor according to claim 1, wherein
a thickness of the first base member is 0.02 mm or more and 1 mm or less.

9. The load sensor according to claim 1, wherein
the second base member is formed from silicone rubber, ethylene-propylene-diene rubber, urethane rubber, fluororubber, nitrile rubber, acrylic rubber, or ethylene-propylene rubber.

10. The load sensor according to claim 1, wherein
the dielectric body is set so as to cover a surface of the conductor wire.
